(19) United States
(12) Patent Application Publication
(10) Pub. No.: US 2015/0077029 A1
(43) Pub. Date: Mar. 19, 2015

(54) Electric Motor Control

(71) Applicant: TRW Limited, Solihull West Midlands (GB)

(72) Inventor: Peter Geoffrey Scotson, Worcestershire (GB)

(73) Assignee: TRW Limited, Solihull West Midlands (GB)

(21) Appl. No.: 14/395,559

(22) PCT Filed: Apr. 19, 2013
(86) PCT No.: PCT/GB2013/051003

§ 371 Date: Oct. 20, 2014

(30) Foreign Application Priority Data
Apr. 20, 2012 (GB) 1206925.8

(51) Int. Cl. H02P 6/00

(52) U.S. Cl. CPC H02P 6/001; H02P 6/002
USPC 318/400.22

(57) ABSTRACT

A drive system for a motor includes a drive stage, a control structure arranged to control operation of the drive stage to control drive current to the motor, and a sensor arranged to generate a temperature output indicative of the temperature of a stationary component of the system. The control structure is further arranged to derive from a current indicator, indicative of at least a component of the drive current, and the temperature output, a rotor temperature indicator indicative of the temperature of the motor rotor.

The present invention relates to motor control systems for permanent magnet motors.

Electric motors are becoming increasingly common in a diverse range of applications. It is known, for example, to provide an electric power steering (EPS) system of the kind comprising an input shaft, an output shaft, a torque sensor adapted to measure the torque in the input shaft, and an electric motor adapted to apply an assistance torque to the output shaft dependent upon the torque measured by the torque sensor. This is one suitable application for the present invention. However the invention is equally useful for electric motors in many other applications.

A typical permanent magnet electric motor comprises a rotor that is magnetic, for example including a permanent magnet, and a stator including a plurality of phase windings on a yoke. Applying suitable voltages across each of the phase windings causes current to flow through the windings, generating a current flux vector in the air gap between the stator and the rotor. This flux interacts with the magnetic field of the rotor to cause the rotor to rotate towards a point of equilibrium in which the current vector is aligned with the axis of the rotor magnetic field. To cause the rotor to turn continuously, the current passed through the windings must be varied in a sequence. This causes the current vector to rotate. This can be achieved by modulating the voltages across each winding under the control of a motor drive circuit.

If the temperature of the permanent magnet rises too high in the presence of a magnetic field from the windings then the magnet can become demagnetised. This can be avoided by limiting the motor current at high temperatures to limit the rotor temperature. However the magnet or rotor temperature cannot be easily measured directly and so must therefore be estimated. Various methods of rotor temperature estimation are known, but there remains a need for improved rotor temperature estimation.

The present invention provides a drive system for a motor, the motor comprising a rotor and a stator. The rotor may comprise a permanent magnet.

The drive system comprises a drive stage, control means arranged to control operation of the drive stage to control the motor, for example by controlling the drive current to the motor. The system may further comprise sensing means arranged to generate a temperature output indicative of the temperature of the drive stage, or another stationary component of the motor system. The control means is further arranged to derive a rotor temperature indicator indicative of the temperature of the rotor. This may be derived from one or more inputs, which may comprise a current indicator, indicative of, or dependent upon, at least a component of the drive current, and the temperature output.

The at least one component of the drive current may be one, or both of a d-axis current and a q-axis current.

The stationary component may comprise a drive stage or a part thereof. For example it may comprise a circuit board or a heat sink, or an individual component such as a transistor or capacitor forming part of the drive stage. Alternatively it may comprise another component through which the drive current or a component of the drive current flows, such as a lead connecting the drive stage to the motor. It may comprise a component which is directly or indirectly heated by the current flowing in the motor, or indirectly heated by the rotor, such as a different part of the motor or motor housing. In one arrangement, it is preferred that the fixed component is not part of the motor, as that would require the motor to be fitted with a sensor. Also, the rotor may not heat up uniformly if the motor is stationary as each phase will carry different currents. The sensing means may comprise a temperature sensor, and may be mounted on, or in thermal contact with, the drive stage or a part thereof. Alternatively it may itself comprise an estimator arranged to estimate the drive stage temperature.

The drive stage may comprise a circuit board with a plurality of switches thereon arranged to control current to the windings of the motor. It may comprise a heat sink. The temperature sensor may be mounted on, or in thermal contact with, any of those components.

The control means may be arranged to determine a series of instantaneous values of the rotor temperature indicator and to apply a low pass filter to the series of values to obtain a filtered value of the rotor temperature indicator. The filtered value may be updated each time the instantaneous value is determined, or less frequently.

The drive current indicator may be indicative of an average of said at least one component of the drive current over a measuring period, or an average of the square of said at least one component, or of its magnitude. Where two or more components of the current are measured, it may be an average of the sum of the squares of those components. The drive current indicator may therefore be indicative of the electric power of the drive current, or at least a component thereof. It may therefore be a drive current power indicator. For example it may vary linearly with that electric power of the drive current.

The control means may be arranged to measure a series of instantaneous values of the magnitude, or the square of the magnitude, of said at least one component of the drive current over a measuring period, and to derive the drive current indicator from an averaging of the series of instantaneous values.

The control means may be arranged to derive the rotor temperature indicator from an averaged value of the temperature output. The control means may be arranged to measure a series of instantaneous values of said temperature output over a measuring period, and to derive an averaged value of the temperature output from the series of instantaneous values.

The control means may be arranged to derive the rotor temperature indicator as being the sum of two components, one of which is indicative of the temperature of the drive stage and the other of which is indicative of the electrical power of the motor current.

A rotor temperature estimation method can use a variety of inputs, which are generally measured or stored parameters. It has been found that the drive stage temperature can be used as one input to the estimator with motor current squared as another. The drive stage temperature provides a measure of the ambient temperature and rises and falls with the motor current much faster than the rotor. The square of the motor current provides a measure of the heat input to the motor (and hence rotor). The inputs vary much faster than the rotor temperature and therefore, to provide a good estimate, these inputs, or the value of the estimated rotor temperature, are preferably heavily filtered.

Other temperature inputs could be used but the drive-stage and rotor both appear to be heated by the motor current. Thus the drive-stage temperature is a good basis for the estimator whereas other temperatures appear to receive heat from different sources.

The system may further comprise any one or more features of the preferred embodiments which will now be described by way of example only with reference to the accompanying drawings in which:

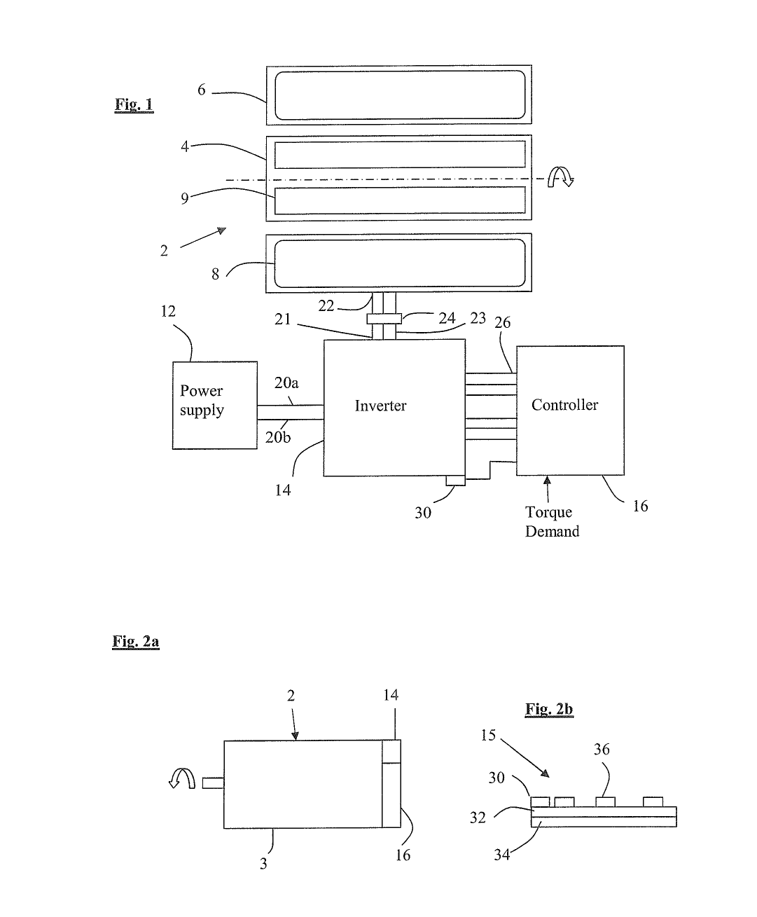

FIG. 1 is a schematic diagram of a motor and a drive system according to an embodiment of the invention;

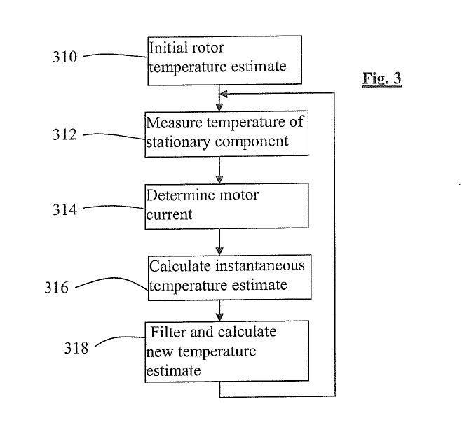

FIG. 2a is a side view of the system of FIG. 1;

FIG. 2b is a schematic section through the drive stage of the system of FIG. 1;

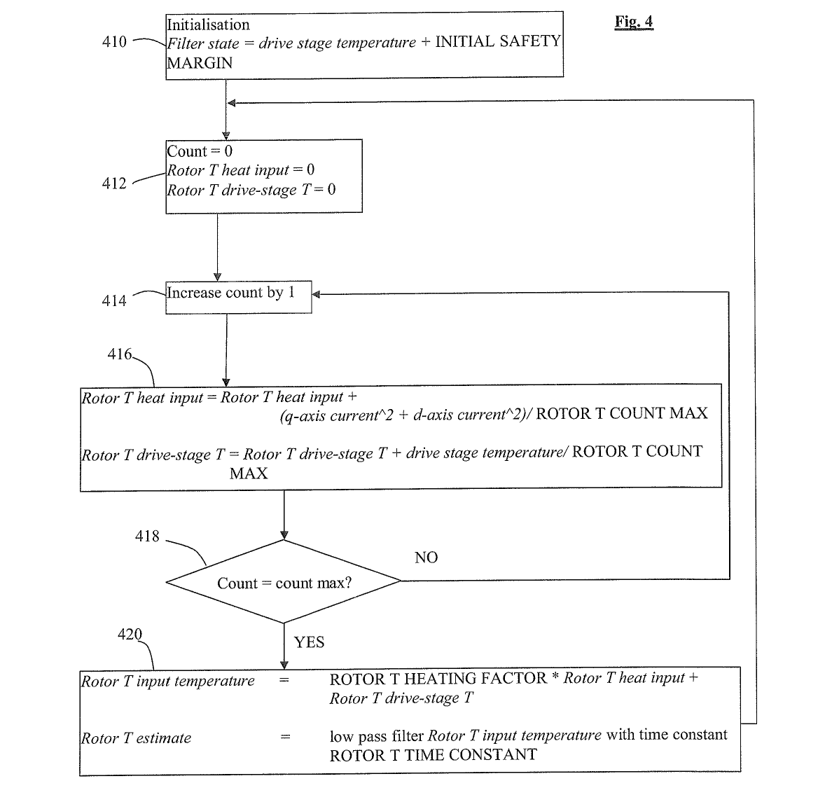

FIG. 3 is a flowchart showing the rotor temperature estimating method performed by the system of FIG. 1; and

FIG. 4 is a flowchart showing an example of the method of FIG. 3 in more detail.

Referring to FIG. 1, in an embodiment of the invention a three phase electric motor 2 is driven by electric current from a voltage source 12, for example a vehicle battery, by means of a drive stage in the form of an inverter 14 under control of a controller 16. The motor 2 comprises a rotor 4 which is connected to the load that the motor is arranged to drive, and a stator 6 on which the windings 8 are wound. The rotor 4 comprises a number of permanent magnets 9 which interact with magnetic fields generated by the windings 8 to drive the motor in known manner. The inverter 14 comprises three pairs of switches, typically transistors, collectively known as the drive stage. Each of the pairs of switches comprises a top transistor and a bottom transistor connected in series between a positive line 20a and negative line 20b from the voltage source 12. Three outputs 21 are each tapped off from between a respective pair of transistors. The outputs 21 are each connected to the respective motor terminal 22 by a lead 23 and current sensors 24 are arranged to measure the drive current in the leads 23.

The controller 16 is arranged to control the drive stage switches 15 in the inverter 14 so as to provide pulse width modulation of the current to the motor windings 8. The controller 16 therefore has six switch control outputs 26 producing switch control signals to the control gates of the six switches. The controller 16 receives input signals from the current sensors 24 from which it can determine the three motor phase currents, and from a temperature sensor 30 arranged to measure the temperature of the drive stage 15. In practice it will receive other sensor inputs to enable it to determine motor speed, and the rotational position of the rotor 4 of the motor 2. The controller 16 also receives a torque demand input and is arranged to control the inverter 14 to drive the motor to produce the demanded torque.

Referring to FIG. 2a, in this embodiment, the motor 2 is housed within a cylindrical housing 3 and the inverter 14, drive stage 15 and controller 16 are mounted on the rear end of the housing 3. However in other embodiments the inverter 14, drive stage 15 and controller 16 can be mounted on the side of the motor housing or even in a separate housing.

Referring to FIG. 2b, the drive stage 15 generally comprises a printed circuit board (PCB) with the transistors 36 of the drive stage printed onto a support substrate 32, and a heat sink 34 arranged to conduct heat away from the transistors 36. The temperature sensor 30 in this embodiment is mounted on the substrate 32 in close thermal contact with the heat sink 34 and is therefore arranged to measure the temperature of the heat sink 34. This gives a good measure of the temperature of the drive stage components themselves.

In an alternative embodiment the temperature sensor can be mounted directly on the heat sink 34 rather than on the substrate 32.

During operation the controller 16 is arranged to generate a temperature indicator which is arranged to provide an indication of an estimated temperature of the rotor 4. The controller 16 is arranged to monitor the value of that temperature indicator and compare it with a limit value which is stored in memory in the controller 16. If the temperature indicator exceeds the limit value, then the controller is arranged to modify its operation to limit or reduce the rotor temperature. In this embodiment the controller is arranged to limit the motor current that it produces to a level that will be expected to allow the rotor temperature to fall, or at least prevent further increase in rotor temperature.

Referring to FIG. 3, the rotor temperature estimation performed by the controller 16 generally comprises a number of main steps which will now be described. A first step 310 comprises setting an initial value of the temperature indicator. This may be set to a predetermined value stored in memory or based on an initial temperature measurement, optionally with the addition of a safe margin. Then at step 312 the temperature of a stationary component is measured. In this embodiment this is the drive stage, but other components may be used for this purpose. At step 314 the current through the motor is determined. In this case the controller measures the current using the current sensors 24. However in other embodiments an estimated current can be used. At step 316 an instantaneous value of the rotor temperature indicator is made using an appropriate calculation based on the measured component temperature and the motor current. This is repeated to generate a series of instantaneous values. Finally, after generation of each of the instantaneous values, a low pass filter function is applied to the instantaneous value and previous values, and a final value of the temperature indicator is determined. This is used as the temperature indicator by the controller 16 which checks this value and determines whether any change in control strategy is needed to limit rotor temperature.

It will be appreciated that the general method described above can be implemented in many different ways by the controller 16, and one example will now be described with reference to FIG. 4. This uses a number of variables as follows:

drive stage temperature is a measured value of drive stage temperature rotor T heat input is an estimate of heat input to the rotor due to the motor current
rotor T drive stage T is an estimate of a component of rotor temperature that varies with the measured drive stage temperature
rotor T input temperature is an instantaneous estimate of rotor temperature
rotor T estimate is a low-pass-filtered value of rotor T input temperature which is taken as the estimated rotor temperature
rotor T execution count is a simple counter that is incremented on each instantaneous measurement of drive stage temperature
and fixed parameters which are stored in memory as follows:
ROTOR T HEATING FACTOR—a factor determining the relative effect of the drive current power on the estimated rotor temperature;
ROTOR T TIME CONSTANT—the time constant of the low pass filter used to filter the series of instantaneous temperature estimates;
ROTOR T INITIAL MARGIN—an assumed initial difference between the rotor temperature and the measured drive stage temperature;
ROTOR T COUNT MAX—the number of instantaneous measurements of drive stage temperature and drive current power used to generate an averaged measurement.

The first step in the process is an initialization step 410 which is performed when the motor is started. This comprises measuring the drive stage temperature to obtain an initial value of the drive stage temperature drive stage temperature and setting the value of rotor T estimate to an initial value

rotor T estimate=drive stage temperature+ROTOR T INITIAL MARGIN

Then at step 412 the values of rotor T execution count, and rotor T drive stage T and rotor T heat input are all set to zero. This forms part of the initialization when the motor is started but is also performed as the first step in a measurement cycle. The controller is then arranged to measure the instantaneous value of the drive stage temperature several times over a measurement cycle period, and derive an average value of the drive stage temperature for that period, and also to measure the instantaneous value of the motor current several times over the same measurement cycle period and derive an average value of the square of the motor current over the cycle period.

The measurement cycle comprises a count increase step 414 at which the counter rotor T execution count is increased by 1, and then a step 416 at which the variables rotor T drive stage T and rotor T heat input are each incremented by an amount dependent on the instantaneous measured values of motor current and drive stage temperature.

At step 418 the count rotor T execution count is compared to the maximum value ROTOR T COUNT MAX, which in this embodiment is 50, but again can be set to any appropriate number. If it has not reached the maximum value the controller returns to step 414, increments the counter rotor T execution count by 1 and repeats step 416. This is done once every 20 ms, though obviously other time periods can be used as appropriate. If at step 418 the count has reached the maximum value, then at step 420 an instantaneous value of estimated rotor temperature rotor T input temperature is derived from the averaged values of rotor T drive stage T and rotor T heat input. This is done using the equation:

Rotor T input temperature=ROTOR T HEATING FACTOR*Rotor T heat input+Rotor T drive-stage T

It will be appreciated that this will be calculated once every second in this embodiment, and these values are stored to form a series of values. This series of values is then filtered with a low pass filter to derive the final rotor temperature estimate rotor T estimate.

Once a new value of the estimated rotor temperature rotor T estimate is obtained, the controller returns to step 412 to start another measurement cycle.

In this embodiment, the fixed parameters can have a range of values from a minimum value up to a maximum, but are set to nominal values as follows:

| Parameter Name | Nom Value | Units |
|---|---|---|
| ROTOR T COUNT MAX | 50 | — |
| ROTOR T HEATING FACTOR | 0.006 | Deg C. A⁻² |
| ROTOR T TIME CONSTANT | 900 | s |
| ROTOR T INITIAL MARGIN | 20 | Deg C. |

It will be appreciated that various modifications can be made to the embodiments and variations described above. For example, the temperature sensor may be arranged to measure the temperature of a specific component of the drive stage such as a transistor or capacitor, or it may be arranged to measure the temperature of another component through which the drive current (or a component of the drive current) flows, such as one or more of the leads 23 connecting the drive stage to the motor. Also, the low pass filtering and averaging of the indicators may be enhanced to adapt the algorithm to other motor and controller embodiments.

1-12. (canceled)

13. A drive system adapted for use with a motor including a rotor and a stator, wherein the rotor includes a permanent magnet, the drive system comprising:
a drive stage,
a controller arranged to control operation of the drive stage to control drive current adapted to be supplied to a motor, and
a temperature sensor arranged to generate a temperature output indicative of the temperature of a stationary component of the drive system, wherein
the controller is further arranged to derive from a current indicator, indicative of at least a component of the drive current, and the temperature output, a rotor temperature indicator indicative of the temperature of a rotor of the motor.

14. A drive system according to claim 13 wherein the stationary component is the drive stage or another component through which the drive current flows.

15. A drive system according to claim 13 wherein the drive stage includes a circuit board with a plurality of switches thereon arranged to control current to the windings of the motor.

16. A drive system according to claim 13 wherein the controller is arranged to determine a series of instantaneous values of the rotor temperature indicator and to apply a low pass filter to the series of values to obtain a filtered value of the rotor temperature indicator.

17. A drive system according to claim 13 wherein the drive current indicator is indicative of the power of the component of the drive current.

18. A drive system according to claim 17 wherein the drive current indicator is indicative of an average of the power of the component of the drive current over a measuring period.

19. A drive system according to claim 13 wherein the controller is arranged to measure a series of instantaneous values of the component of the drive current over a measuring period, and to derive the drive current indicator from the series of instantaneous values.

20. A drive system according to claim 13 wherein the controller is arranged to derive the rotor temperature indicator from an averaged value of the temperature output.

21. A drive system according to claim 13 wherein the controller is arranged to measure a series of instantaneous values of the temperature output over a measuring period, and to derive an averaged value of the temperature output from the series of instantaneous values.

22. A drive system according to claim 13 wherein the controller is arranged to derive the rotor temperature indicator as being the sum of two components, one of which is indicative of the temperature of the stationary component and the other of which is indicative of the electrical power of the component of the drive current.

23. A drive system according to claim 13 wherein the controller is arranged to compare the rotor temperature indicator with a limit value and, if it reaches the limit value, to modify its operation.

24. A drive system according to claim 23 wherein the controller is arranged to modify its operation by limiting the drive current it will produce.
